(19) United States
(12) Patent Application Publication
(10) Pub. No.: US 2015/0089397 A1
(43) Pub. Date: Mar. 26, 2015

(54) SOCIAL MEDIA HATS METHOD AND SYSTEM

(71) Applicants: Alex Gorod, Brooklyn, NY (US); Veronica Shipilov, Brooklyn, NY (US); Alexey Bakman, Brooklyn, NY (US)

(72) Inventors: Alex Gorod, Brooklyn, NY (US); Veronica Shipilov, Brooklyn, NY (US); Alexey Bakman, Brooklyn, NY (US)

(21) Appl. No.: 14/492,042

(22) Filed: Sep. 21, 2014

Related U.S. Application Data
(60) Provisional application No. 61/880,891, filed on Sep. 21, 2013.

(51) Int. Cl. G06F 3/0482; G06F 3/0484; H04L 29/06; G06F 17/30

(52) U.S. Cl. CPC G06F 3/0482; G06F 17/3089; G06F 3/04842; H04L 65/403
USPC 715/753

(57) ABSTRACT

The invention describes and claims a computer-implemented method and system of virtual exposure management for expeditious alteration of user's exposure characteristics in a social media environment. The system and method comprise a plurality of virtual exposure modes, corresponding to a set of social media data. The system and method further comprise a communication device that allows for user's selection of a set of options, including the selection of a virtual exposure mode. The method and system further comprise a set of linking data, with information for proper association of each virtual exposure mode with corresponding social media data.

### PRIORITY

This application claims priority to the provisional application No. 61/880,891 for SOCIAL MEDIA HATS METHOD AND SYSTEM, filed on Sep. 21, 2013.

### BRIEF DESCRIPTION OF THE DRAWINGS

FIG. 1 illustrates one of the preferred embodiments of the invention, as it would appear to a user on a GUI interface, presenting the user with a selection of virtual exposure modes.

FIG. 2 illustrates another preferred embodiment of the invention, as it would appear to a user on a GUI interface, presenting the user with a selection of virtual exposure modes.

FIG. 3 illustrates a schematic representation of one of the preferred embodiments of the virtual exposure system of the present invention.

FIG. 4 is the flow chart, illustrating, in no specific order, the steps of the method of one of the preferred embodiments of the present invention.

FIG. 5 illustrates a general interaction of the user with social media environment through one of the embodiments of the system and method of the present invention.

FIG. 6 illustrates a general interaction of the user with social media environment through one of the embodiments of the system and method of the present invention.

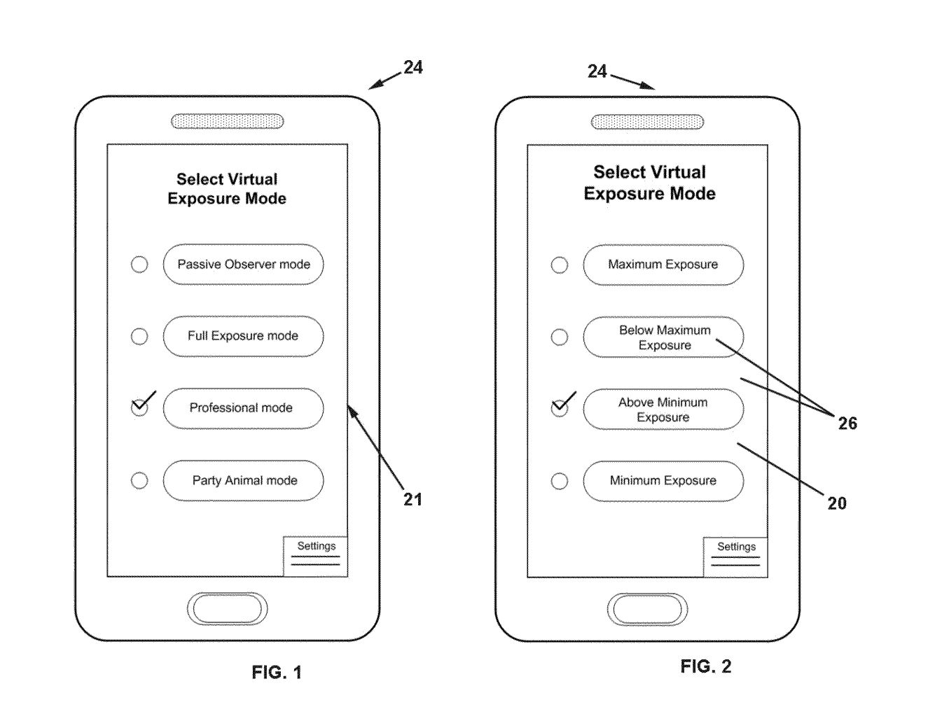

### FIELD OF THE INVENTION

The field of this invention is social media, and more particularly a computer-implemented system of social media exposure management.

### BACKGROUND OF THE INVENTION

As social media sites grow and develop, they penetrate our culture and private lives ever deeper. For many people, especially those of the younger generation, personal and digital lives have long become intertwined and inseparable from one another. For “Facebook Generation,” the virtual persona is becoming a complete digital reflection of our real one. Well, almost complete.

In one respect the social media persona has not been able to keep up with our real persona. In real life we don on a lot of hats. Both literally and figuratively. We dress up and behave in different ways for different occasions of our lives. Depending on the situation, we vary in the games we play, the personalities that we display and social modes that we take up. Sometimes we are open. Sometimes we are secretive. Sometimes were whimsical. Sometimes were serious. The way we see ourselves and how we present to others change from day to day, from hour to hour, with changes in our comfort, mood and our surroundings. In every mode, we emphasize some sides of our personality, and hide the others.

When we're invited by the Queen of England for some tea, well wear a top hat and a tuxedo. And we'll behave ourselves in ways that are most formal. But when we're at a game with friends, we wear a baseball hat. And we may well drink our beers straight from the bottle neck, be loud, be relaxed. We switch or social relationship hats at will as well. We are a boss to some and an employee to another. We are in our parental hats before our kids, and in our children's hat before our parents. Sometimes we wear the seller's hat, sometimes that of the buyer. We're different in each role. Our looks and personalities are fluid and forever changing.

If stranger was to meet us on a random day in our lives, he may well judge us based on our “hat” that day. Was it a hat of power or a hat of weakness? Was it a hat of kindness or of coldness? Was it a ragged straw or golden crown?

Yet our digital persona is more static than ourselves. It wears all the hats at once. If the same stranger was to visit our Facebook page on random day, he would see our digital persona wearing many hats at once. Hundreds of images we posted on the wall in all those years, innumerable tweets we tweeted, all show us in different “hats”. Here, we are students. There, the teachers. Here, we are sinners. There—the preachers.

On any given day, social media sites stand ready to display the aggregate of our personalities, all our “hats.” We may be sad that day, but our friends can find our happy pictures on our virtual walls. We may be studying for an exam, but they can see the pictures of us partying all through the night. The always-available aggregate of our posts on social media, is not consistent with a personality and a social message that we may want to flag at the moment, now.

If we are happy, and in celebration, we may want our social media sites to show our happy state with all the content, with the background, links and music. We may not want our friends who visit our site that day to see the suicidal posts and gothic graphics. Just like our real self that may be only singing happy songs that day, we may want our digital representation of ourselves, our digital persona, to exude the brightness, happiness and hope. Alternatively, when we are sad or are in meditative mood, we may want to convey that mood with all the content on our social media sites. We may want our friends to see the grayish background, to read only our lonely lyrics and to hear the sounds of sorrow on our sites.

Yet, it is nearly impossible today to keep our digital persona's mood consistent with our own mood on hourly or daily basis. Sure, one can set their social media site to a certain tone. If one is in a gloomy mood, one may spend many hours or days deleting happy pictures and all happy thoughts. But when life turns to the better and the mood improves, do they spend hours again reposting all deleted pictures and old posts? For most, such time-consuming social media make-overs are too laborious to undertake. And sometimes, it is just unpractical.

Imagine, for example, a job interview. The applicant will usually come well dressed, well washed, on best behavior all around, in order to impress perspective bosses. His real persona is in a professional mode. Yet what will happen if the boss decides to see the applicant's behind-the-scenes persona, his social media self? And most employers do just that, right after the interview, these days. Employer may then see the applicant at parties, in revealing clothes, associating with some questionable friends, pulling illegal stunts, philosophizing fearlessly on most sensitive of issues. At such a moment, the applicant may well wish for a magic wand to instantly transform all his social media profiles to host just the professional images and most proper posts. The system and method of the present invention provides just such a magic wand for social media users. The present invention allows the user to reduce a risk of being caught in the wrong persona, wearing the wrong hat. It allows the user to almost instantaneously change his or her social media image to a preset one, appropriate for the situation. The present invention allows for instant changing of the image on not just one, but across several social media platforms simultaneously.

Our social media self has become such a natural extension of ourselves that we rarely stop and think about the traces we live online. Most think of social media sites as a personal journal, open to the closest friends. Most post their innermost feelings, thoughts and doubts. Few stop to think of who may read these posts today, tomorrow, or ten years from now. Few stop to think of what effects these posts may have on their future. What risks and hazards these old posts present. Few realize how offensive many of the half-thought-out blurbs may be to others. Few can imagine how their own world-views will change years from now. But the posts remain, forever skewing our digital persona from what we really are today. Distorting our digital persona what we want or need to be on a particular day. And forever creating unquantifiable risks of exposure for our real-world selves.

Therefore, there is a long-felt and unmet need in the art of social media for a tool that would allow social media users to alter their social media “selves” to conform to their current moods, world views and social situations. Just like our real personas change literal and figurative hats in life to express ourselves, achieve various goals and to conform to various situations, the tool should allow the user to change the look, feel and content of their social media selves'. Such alteration must be prompt, simple and efficient. Much more prompt, simple and efficient than what is available by manually adjusting the settings and adding and/or deleting individual content on various social media sites. The tool must allow the user to instantly hide or remove the social media content that may be harmful or unwanted in a particular situation, while leaving or emphasizing the content that may be helpful or wanted in a particular situation. The tool should be customizable for user's particular situations, wants and needs. The tool should allow for groupings of particular settings, content and visual characteristics to provide for efficient use in numerous and various situations.

The system and method of the present invention achieves these objectives and provides numerous other benefits.

### SUMMARY OF THE PRESENT INVENTION

The invention describes and claims a computer-implemented method and system of virtual exposure management for expeditious alteration of user's exposure characteristics in a social media environment. The system and method comprise a plurality of virtual exposure modes, corresponding to a set of social media data. The system and method further comprise a communication device that allows for user's selection of a set of options, including the selection of a virtual exposure mode. The method and system further comprise a set of linking data, with information for proper association of each virtual exposure mode with corresponding social media data.

### DETAILED DESCRIPTION OF THE PREFERRED EMBODIMENTS

The system and method of the present invention will now be illustrated by reference to the accompanying drawings. Preferred embodiments of the computer-implemented system and method of virtual exposure management of the present invention (also referred to as the System 10 or Method 10) have been assigned reference numeral 10. Other elements have been assigned the reference numerals referred to below.

The computer-implemented system and method of virtual exposure management 10 is intended for providing simple and expeditious modification of user's 12 exposure characteristics in a social media environment 14. The term “user” 12, of the preferred embodiments, refers to the human user of System 10. Such user 12 may be a typical social media user with one or more accounts on various social media sites, such as Facebook, Google+, Twitter, Youtube and/or hundreds of other social media sites. The term “social media environment” refers to the user's 12 presence on such social media sites. For example, if the user has accounts on Facebook and Twitter, a reference to the user's 12 social media environment 14 may refer to his/her presence and interaction on Facebook, or Twitter, or both. Each such account in the user's social media environment 14 has certain virtual exposure characteristics 16 (also referred to as exposure characteristics 16 or virtual persona characteristics 16). In the preferred embodiments, such virtual persona characteristics (or characteristic) 16 may be selected from a group of characteristics that comprise among other characteristics: user's 12 privacy settings on each social media sites, the overall look and feel of each site, what photographs, videos, and textual messages were posted by the user. In some embodiments, the number as well as the content of the user's 12 posts may be considered in determining the virtual persona characteristics 16. In other embodiments, for example, only the user's privacy settings may be considered.

There may be certain desirable and undesirable virtual persona characteristics 16 present in the user's 12 social media environment 14 at a certain time. There may also be some virtual persona characteristics 16 that are desirable, but are not present in the user's 12 social media environment 14 at a certain time. Which virtual persona characteristics 16 are desirable, and which are not may depend on the type of virtual “personality” that the user desires to select on a particular date, on the type of the “virtual hat” that the user desires to wear.

The preferred embodiments of the present invention, group the virtual persona characteristics 16 into a plurality of sets, referred to as the “virtual exposure modes” 18 (modes). The preferred embodiments of the present system and method 10 allow for establishing 102 a plurality of virtual exposure modes 18. Such modes are either pre-set/pre-established by the system/method 10 and/or are establishable and modifiable by the user. Each exposure mode 18 comprises/correlates 104 to a number of the virtual persona characteristics 16.

The preferred embodiments of the present invention comprise at least two, but preferably more than two virtual exposure modes 18. The virtual exposure modes 18 are selectable by the user through of the use of the GUI interface 20 on the display device 21 of the user's communication device 24.

The communication device 24, provided 108 by the method and system of this invention may be any device with access to the social media environment 14, such as an internet-connected computer or a smart phone with a touch-screen input device 26 (i.e. a touch screen) and an LCD display device 21. The GUI interface 20, is configured to allow for user's selection of a set of options on the display device 21, including, but not limited to the selection of the modes 18 and various set-up and implementation options presented by the system 10.

When using the system 10 of the preferred embodiment, the user may, at a certain point, be presented with the selection of several virtual exposure modes 18. These modes 18 may be thought of as the distinct digital “personalities,” each with a particular set of traits (i.e. virtual persona characteristics 16). The user 12 may decide which “Personality” (virtual exposure mode 18) to select at a particular time, depending on his/her personal circumstances. In the preferred embodiments, the modes 18 are labeled with names associated with the types of “personality” that they represent. The types of “personalities” (or modes 18) may be based on the visibility/exposure settings on the social media or the content of the posts, the overall look, background color and graphics, and/or any of these and other virtual persona characteristics 16.

For example, in one of the embodiments, upon logging in and authenticating into the system 10, the user may be presented with the choice of the following virtual exposure modes: PASSIVE OBSERVER MODE, FULL SOCIAL EXPOSURE MODE, PARTY ANIMAL MODE, ROMANTIC MODE, JOB APPLICANT MODE, PROFESSIONAL MODE, DEPRESSED MODE, VACATION MODE, DEFAULT MODE, among numerous other possible modes 18. Each of these modes 18 is associated with certain virtual persona characteristics 16. In the preferred embodiments of the present invention, some of the modes 18 are associated with characteristics 16 according to the user's selection, and some of the modes 18 are associated with characteristics 16 according to the system pre-sets, modifiable by the user 12. Yet in other embodiments, all of the associations between the modes 18 and characteristics 16 may be done either entirely by the user 12 or entirely pre-set by the administrators of system 10.

In the preferred embodiments, some modes, such as the DEFAULT MODE, PASSIVE OBSERVER MODE and/or FULL SOCIAL EXPOSURE MODE may be pre-set for user 12 by the system 10, while other modes may be invented, selected and/or created by the user according to their lifestyle and social exposure needs. The selection can be made according to the general exposure preference (e.g. FULL SOCIAL EXPOSURE MODE) or according to content (e.g. PROFESSIONAL MODE, where formal, job-related content is emphasized and non-related content is de-emphasized or blocked/hidden/removed).

In the preferred embodiments, the transformation/alteration of user's exposure characteristics is carried promptly right after the user selects and/or confirms the choice of one of the modes 18 on the GUI interface 20. From the perspective of the user, the process appears seamless and nearly instant. For example, the user may be headed to an interview, and assumes that the employer will be browsing through his/her social media sites. The user selects/clicks the “PROFESSIONAL MODE” on the GUI interface. Such action will apply a range of instant alterations in user's social media environment. Such alterations may be applied across one social media site, such as Facebook, or across several social media sites simultaneously. As soon as the “PROFESSIONAL MODE” mode is selected, some of the pictures previously posted by the user, such as the pictures displaying childish or non-professional behavior, disappear. Instead, new pictures of the user in business clothing may be posted or moved to the top of the photography gallery. Some textual posts may be deleted and/or replaced with posts demonstrating the user's good work ethic and professional involvement. All the colorful frilly backgrounds will be replaced with solid black and white. Certain friends or associations may become invisible, while others may be emphasized to the visitor. Depending on the impression the user is trying to make, privacy settings will be adjusted to make the entire profile more or less visible to the potential employer. That is, unless the user is seeking a job in an unconventional or artistic field. In that case the effects may be reversed and the “PROFESSIONAL MODE” for such a user will emphasize all the unusual, creative and artistic in the profile.

Similarly, the user 12 may go out to a nice restaurant for a first date and fall in love at first sight. The user may feel romantic and may want to share these feelings with friends, visitors to his/her social media world, and with that special other person, should he/she decide to visit the social media site. Then, with the flick of the finger, the user 12 selects the “ROMANTIC MODE”. As if by magic, all of the whiny posts, and pictures of dirty dishes and of messy eating contests disappear to be replaced with pictures of knights in shining armor, deep purple backgrounds and posts of romantic poetry.

Alternatively, if the user wants to disappear from the public (social media) eye, he or she may select one of the privacy modes, such as the PASSIVE OBSERVER mode. In such a mode, the content and graphical aspects of the user's social media environment may remain the same. However, a number of the privacy settings may be automatically adjusted by the system 10 across one or several of user's social media sites. The user 12 may become less visible to others, less of the subject to pokes, wall writings and instant texts. Yet, he/or she may still be able to passively observe and, to some extent, participate in social media life.

The preferred embodiments of the System 10 are presettable by the user to apply such changes across any or all social media accounts held by the user 12. Thus, the user may want to apply the PROFESSIONAL MODE on one social media site, while remaining in the ROMANTIC MODE or FULL EXPOSURE MODE on another. Furthermore, the present invention anticipates that in some embodiments, two or more modes may be combinable simultaneously on the same social media sites. For example, it is foreseeable that PROFESSIONAL MODE and PASSIVE OBSERVER MODE may be implemented without conflicting with each other. Alternatively, the conflicts may be resolved with preferences from one mode taking precedence over the preferences from another mode, where both modes are simultaneously selected.

The user may want to apply the modes 18 to his/her social media environment for a number of reasons. It is expected that in most cases, the application of modes will be used not so much to conceal, but rather to emphasize a certain part of the user's 12 personality. Perhaps, this emphasis on a certain trait will be achieved by temporarily clearing away unnecessary and misleading debris that clutter much of the social media. As mentioned above, we wear different social hats in life and behave differently at different times and in various situations. Thus, the modes may be applied not to deceive, but to emphasize a side of our personality. Certain images, tones and behaviors are sometimes just not appropriate. One may be a comedian professionally and in everyday life. But it will be inappropriate for this comedian to crack jokes at a funeral. And noone will object to seeing a funeral director, who must be somber at work, laugh at the comedy club. Would it not be appropriate for the comedian's entire Facebook page to gloom down and become serious on a national day of mourning to reflect his inward and outward appearance in real life? Would it not be appropriate for the funeral director's personal Facebook page to bloom with flowers and speak only of happy things on his daughter's wedding day? Through the use of the present invention, users' social media sites will reflect accurately, who they really are and how they feel on this day.

Naturally, the modes 18, applying a number of changes to the user's social media, may (in some embodiments) require extensive pre-sets, either by the user, by system's 10 administrators, or automatically by system 10. As discussed above, each mode 18 is preferably associated with a set of characteristics, 16. For example, the user 12 may decide on what the characteristics 16 of the ROMANTIC MODE are. For a certain user, this mode may be associated with the following characteristics 16: the presence of dark red color in the background, the presence of soft music, the presence of smile on the photographs, the presence of mystery in the photographs, the emphasis and repositioning to the front page of pictures with flowers and horses, the absence of sad faces on the photographs, the absence or rude textual posts, the presence of poetic posts, and maximum exposure of the profile to all visitors to emphasize loving and friendly nature. In some embodiments, such characteristics 16 for a mode 18 may be decided upon by the user and kept in user's head. That is, in some embodiments, this step of correlating 104 the characteristics 16 with a certain mode 18 may be mental. Alternatively, such characteristics 16 may be entered by the user 12 into the system 10, or selected by the user 12 from the choices presented by the system 10. In any case, once the characteristics 16 are decided upon, each virtual exposure mode 18 must be correlated 106 (that is, linked) to a set of social media data 22.

The term “social media data” 22, as used in this description and the claims below, refers to actual digital data, such as pictures, text posts, files, etc., already located in the social media environment, such data that may be posted on social media sites as part of the mode 18, as well as to the functions/settings available on each particular social media site through that site's API controls. The term “social media data” 22 is distinguished from the virtual exposure characteristics 16 in that the latter may refer to ambiguous data and social exposure characteristics, such as “all pictures with a smile, and set a low social exposure setting”, while the former refers to the actual concrete data and settings, identifying the above-mentioned pictures and settings in an unambiguous way, such as the “file XYZ positioned in folder ZYX on X social media site, and the “visible-to-family-only” setting switched on.” The term “social media data” 22 also refers to data that has not yet been posted on the social media site, but may be posted as part of the process activated by the selection of a particular mode 18. The “set of social media data” 22 refers to a set, a grouping, of such defined data and settings.

In the preferred variants of the invention, upon the first logon and authentication into the system 10, the user may be asked to pre-set or to customize the associations between the modes 18 and the social media data 22. The user may also be asked to create new custom modes 18 that suit his/her moods, life situations and perceptions of self.

In some preferred embodiments, the correlation 106 of a virtual exposure mode 18 with a set of social media data 22 may be as simple as follows:

The user 12 selects a mode 18 to set up. The system 10 accesses the data in the social media environment through each social media sites particular API. The user 12 is presented with his/her data from the user's 12 social media environment and/or the data stored in System 10's databases (and postable in social media environment) through the System's 10 GUI.

In one of the embodiments, the user is presented with an image overlay of a plus or minus (or possibly a check mark or other similar selection method) on top of a photograph, a post, or other social media. The user can then select whether he/she wants a particular piece of data to be posted, removed, emphasized or to remain untouched on his/her social media when a particular mode 18 is activated. In some embodiments, the user may then be allowed to select particular privacy settings for each mode 18. The user may select the settings from the number of options on the System's 10 GUI interface or be guided in the selection by a number of privacy and social media risk-centered questions presented by the system 10.

In the preferred embodiment, at least some of the social media data is uploaded into the user's social media environment through the System 10. The user first uploads the file (such as one of his/her pictures) to System 10. The system 10 then accesses the social media networks through their respective API interfaces to post the user's images/textual posts. In such an embodiment, the user 12, at the very time of the initial upload, may select the association of each particular post (made through System 10) with one or more modes 18. The user may indicate whether the file will be visible or invisible in a particular mode. For example, upon uploading of the picture, the user 12 may select through the System's 10 GUI interface, in which modes 18 the image will be visible. The user may click one or several modes, or select “none.”

In some instances, the user may not want a file to be posted in the social media environment instantly. Instead, the user may want the file to be only posted when a certain mode is activated (such as, the picture with a rose in the mouth will only be activated in the Romantic mode). The preferred embodiments of the present invention allow for such user's choice. In these embodiments, such file, reserved for later posting is initially stored in a social media file storage database 23 (file database 23). Such data that has not yet been posted, but may be posted when a certain mode is selected is considered to be part of the social media data 22 for purposes of this description and claims below.

The user's selections are saved for future reference when the user eventually activates one of the modes 18 through the GUI interface. The GUI interface, provided 110 in the preferred embodiments, is configured to allow for user's selection of a set of options on the display device, said set of options comprising the selection of a virtual exposure mode 18. That is, when the user decides to implement a certain mode, the preferred embodiments of the invention will allow him/her to make such a selection of a previously user-preset or automatically-preset mode 18.

Until a mode 18 is implemented by the user, the setting selections for each mode 18 may be saved in the user's device, but are preferably saved in a provided 114 linking database 25 (also referred to as the linking database 25), comprising a set of linking data 26. The linking database 25 is preferably positioned on a server. Although, in some embodiments, the linking database 25 may be stored locally on the user's device. The linking data 26 comprises the association information for proper association of each virtual exposure mode 18 with corresponding social media data 22. The linking data specifies what actions must be carried out on which particular social media data 22 in correspondence with the selection of each mode 18. The linking data may comprise information for both positive and negative actions. That is, posting or modifying, as well as removing certain posts, and adjusting certain settings in some or all of the social media accounts associated with the System 10.

As mentioned above, in some embodiments, the association between at least some of the modes 18 and some of the social media data 22 (such as what privacy settings to apply in each mode, the posts with which keywords to definitely remove in each mode) is pre-set by the System 10 (and may be modifiable by the user). In other embodiments, such association is settable/modifiable by the user.

In certain embodiments, the System 10 may automatically identify media data 22 in accordance with characteristics 16. Such characteristics in some embodiments are selectable from a checklist. For example, the user 12 may be asked which photographs does he or she want to associate with the ROMANTIC MODE. The user may select a number of photography characteristics from the list, such as: smiling, sprinkle in the eye, saturated colors, movement, formal suits. The user 12 may then be presented with a number of options to select in the textual posts, such as the posts about love and/or compassion and/or containing sophisticated words, for example. The user may be presented with a number of options of which characteristics 16 to deselect in a particular mode. The user may, for example, de-select any pictures with angry expressions and any word posts containing cursing words. The user may also be presented with a selection of certain privacy or social exposure settings, such as “implement maximum visibility of my profile.”

Once System 10 receives user's entries through the GUI interface, the system must now translate the characteristics 16, selected by the user, to come up with identification of particular media data 22 (i.e., which particular photographs are the smiling ones) and the linking data 26 (i.e. what actions to apply to smiling photographs). The translation of the characteristics 16 and the identification of the particular media data 22 in the preferred devices is carried out by a processing device 30. Preferably, such a processing device (processor 30) is located remotely from the user 12, although in some embodiments the processor of the user's communication device, such a smartphone or a computer may be used.

The data (such as posts in the user's social media environment as well as file storage database 23 is then analyzed in accordance with algorithms known to those in the art of image analysis and text analysis. Some digital cameras, for example, now have a smile mode, where camera's processors analyze the image, and recognize a smiling face, triggering the shutter. Such analysis may involve calculations of the position, shape, length and other characteristics of the lips, eyes, and other identifiers on the face of the user and comparing the calculations against certain characteristics in a database to identify whether certain facial expression equates to a smile. Similar approach may be used by the processing device 30 of the System 10 to identify smiles, anger, or any other expressions or objects on the photograph. The presets for thresholds identifying particular expressions or objects may be taken from third-party databases or particularly preset for the System 10. Text-analysis algorithms, may be used to determine whether the text post is, for example, romantic or angry. And a word search in the user's social media environment as well as file storage database 23 may reveal whether the user's textual messages contain any words, classified as inappropriate in a database. In some embodiments of the System 10, outside, third-party processing services may be implemented as part of the steps to identify the media data 22 that corresponds to the pre-selected characteristics. In preferred embodiments, once the user's selections are translated into tangible associations and commands applicable to particular social media data 22, and once this data 22 is correlated 106 with a particular mode 18, System 10 saves these associations in a linking database 25 as a set of linking data 26.

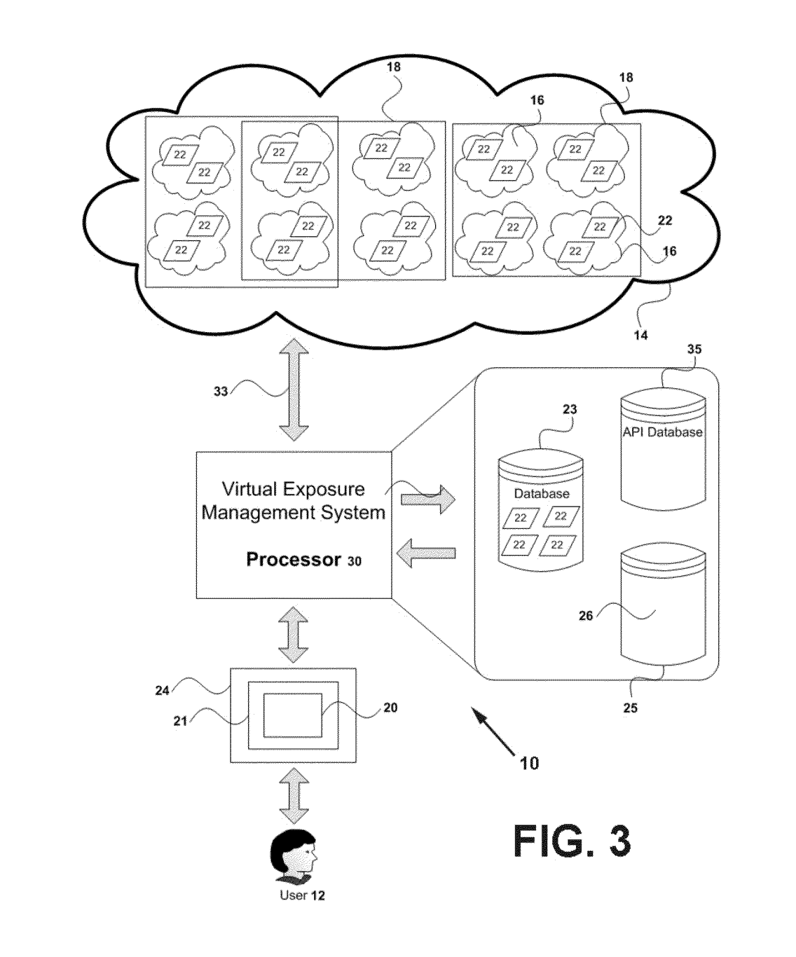

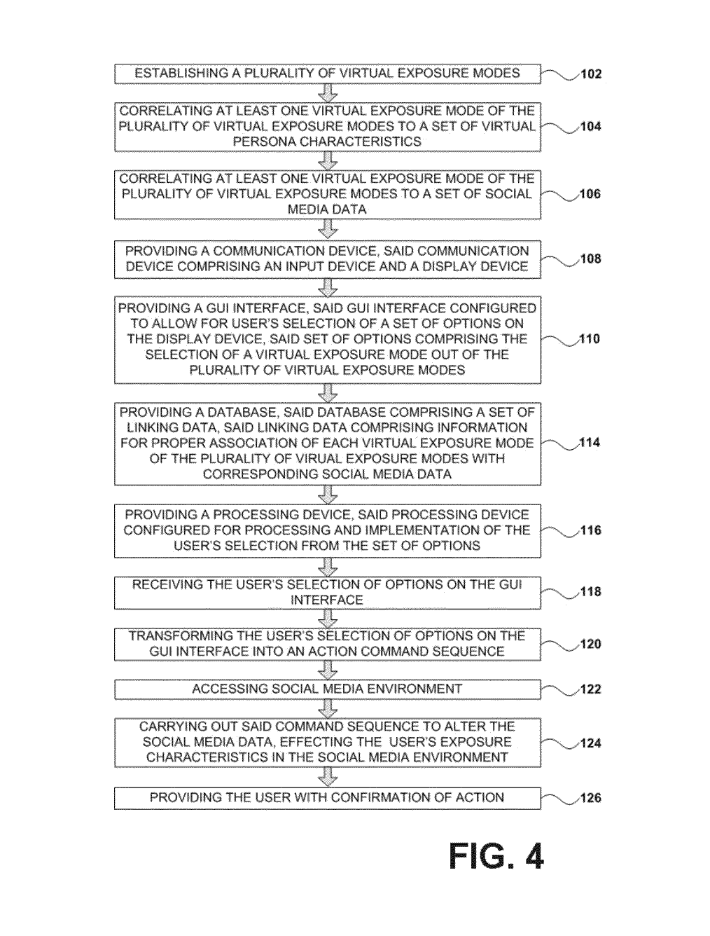

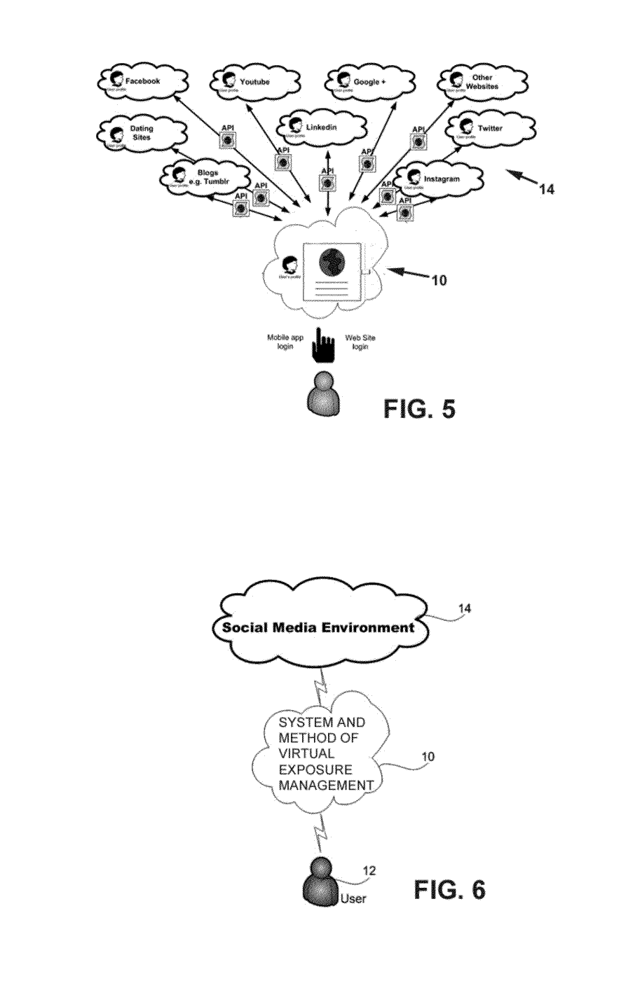

It should be noted that particular pieces or sets of media data 22 (such as particular photographs or texts) are not limited to associations with one mode 18. Instead, each piece of media data 22 or even a whole set of media data 22 may be the same for two or more modes 18 of System 10. This principle can be seen in FIG. 3, which illustrates sharing of several pieces of media data 22 shared among several modes 18. In fact, in some embodiments, some modes 18 may be the aggregates of several modes 18. Thus, for example, one of the embodiments may comprise a SMART CASUAL mode, which may comprise the combination of all of the non-conflicting settings of the ROMANTIC MODE and THE PROFESSIONAL MODE, which settings of the PROFESSIONAL MODE taking preference in case of conflicts.

As stated above, all embodiments of the System 10 comprise/provide 116 a processing device 30, preferably associated with a server and positioned in a location, remote from the user. Said processing device 30 is preferably configured for expeditious processing and implementation of the user's selection 118 from the set of options. That is, in the preferred embodiments, implementation of the pre-selected actions for a particular mode 18 selection are set in motion as soon as the selection 118 is made by the user 12. When a particular mode 18 (ROMANTIC MODE, for example) is selected by the user, the System 10 transforms 120 the selection into an action command sequence 33. As part of such action command sequence 33, the System 10 accesses the linking data 26, so as to determine what particular actions must be carried out in order to implement a particular mode. System 10 transforms 120 these particular actions into a set of API commands. The API commands may be generated by the system 10 after the selection of the mode by the user, or, preferably, pre-generated at the time of the initial set-up of each mode 18 and stored in the command database 35. After the user 12 selects a mode 18, the system accesses 122 the social media environment 14. That is, a set of commands is sent to a particular social media site (such as Facebook or Twitter). If a particular mode requires changes on more than one social media sites (Such as changes to both Facebook and Twitter accounts), several sets of APIs may be transmitted by the System 10. As most social media sites use APIs unique to their particular service, two or more sets of APIs may be generated and transmitted by the System 10 to the respective social media services.

The API command sequence, once it is carried out, alters the social media data 124. That is, certain posts (consisting of photographs, texts, background images, background music, animations, and/or other media) are removed, others are added or edited. A change in certain exposure and/or profile visibility settings may be implemented. All of these changes have an effect on the user's exposure characteristics in the social media environment 124. That is, following the implementation of a certain mode 18, user's social media sites may present a different look and feel to the visitors. Moreover, the content may have changed. The exposure/visibility of the profile to third-party visitors may have been expanded or reduced. All of this has an effect on the degree of social media risk that the user 10 exposes themselves to. While the level of acceptable social media risk and exposure generally varies among individual users, it also varies with changing circumstances for all individuals. The present invention offers the user a measure of control over their current exposure, which may be changed depending on the changing circumstances.

Once, the command sequence is carried, the System 10 of the preferred embodiments provides the user 10 with the confirmation of action 126. Such confirmation may be a statement of the actions that were undertaken and the success or failure of implementation of a particular mode. The confirmation is preferably a publication, indicating the outcome on the command sequence on the display device 21. Such confirmation may be as simple as a green button lighting up on the screen of a mobile device, indicating that all went well and a particular mode is implemented. In some embodiments, the confirmation may be much more detailed, providing an in-depth report of all the changes implemented to each social media sites, including which changes were successfully carried out and which were not. In some embodiments, the confirmation comprise a report with analysis of the user's current social media risk and exposure. In some embodiments, such analysis and the level or risk is generated as a quantifiable score of user's risk and/or exposure. The term “publication” refers to printed confirmation, as well as to audio, video, and other signals presented to the user to report the outcome of the attempted implementation.

It must be noted that implementation of a particular mode 18 need not always be associated with obviously noticeable changes to the user's social media profiles. The present invention anticipates the presence of modes 18, that require no removal or addition of posts for implementation. For example, in one such embodiment of the present invention, the System 10 may comprise modes 18 associated purely with user's 12 social visibility and/or risk. Such embodiment may comprise the following four modes 18, for example:

### Minimum Exposure, Above Minimum Exposure, Below Maximum Exposure, Maximum Exposure.

The modes are preferably more creatively named, such as “THE HIDING MODE,” or “THE PASSIVE OBSERVER MODE” for the MINIMUM EXPOSURE mode, for example. The implementation of one of these modes by the user will apply (though API commands sent to the social media sites) a set of exposure settings. For example, the MINIMUM ESPOSURE mode, all exposure settings will be minimized to the extent possible, so as to allow the user to observe, but not to participate in social media events. The settings for such a mode are configured, so as to allow minimal visibility of the user's profiles and social media presence to third parties. The MAXIMUM EXPOSURE MODE implements the opposite settings, allowing for maximum visibility and maximum disclosure of the user's 12 online presence. The intermediate modes, will appropriately implement an intermediate level of exposure. Such exposure modes allow the user to promptly implement a number of social media settings to set exposure, appropriate for the mood, and the circumstances.

The presence of such exposure modes further allows for distinct qualification of the social media exposure risk. Such qualification will allow a parent to limit a child's social media use to a certain exposure level only (such as ABOVE MINIMUM EXPOSURE). Similarly an employer may limit the use of the social media sites to a particular mode that they deem sufficiently safe for the employees and the company.

It is to be understood that while the system and method of this invention have been described and illustrated in detail, the above-described embodiments are simply illustrative of the principles of the invention and the forms that the invention can take, and not a definition of the invention. It is to be understood also that various other modifications and changes may be devised by those skilled in the art which will embody the principles of the invention and fall within the spirit and scope thereof. It is not desired to limit the invention to the exact construction and operation shown and described. Nor is it desired to limit the method steps described in the description and/or the claims below to a particular order of execution. The spirit and scope of this invention are limited only by the spirit and scope of the following claims.

1. We claim:
a computer-implemented system of virtual exposure management for expeditious alteration of user's exposure characteristics in a social media environment, the computer-implemented system comprising:
a plurality of virtual exposure modes
wherein each virtual exposure mode of the plurality of virtual exposure modes corresponds to a set of social media data;
a communication device, said communication device comprising an input device and a display device;
A GUI interface, configured to allow for user's selection of a set of options on the display device, said set of options comprising the selection of a virtual exposure mode out of the plurality of virtual exposure modes;
A database, comprising a set of linking data,
said linking data comprising information for proper association of each virtual exposure mode of the plurality of virtual exposure modes with corresponding social media data;
a processing device, said processing device configured for processing and implementation of the user's selection from the set of options.

2. The computer-implemented system of claim 1, wherein
said implementation comprises the steps of:
transforming the user's selection of options on the GUI interface into an action command sequence, and
of carrying out said command sequence to alter the social media data effecting the user's exposure characteristics in the social media environment, and
providing the user with the confirmation of action, said confirmation comprising the publication of such confirmation on the display device.

3. The system of claim 1, wherein each virtual exposure mode of the plurality of virtual exposure modes corresponds to a set of virtual persona characteristics.

4. The system of claim 3 wherein at least some data in at least some of the sets of social media data is pre-selected by the user to correspond to a particular virtual exposure mode of the plurality of virtual exposure modes.

5. The system of claim 1 wherein at least some data in the set of linking data is entered based on user's selections on the GUI interface.

6. The system of claim 3 wherein at least some data in the set of linking data is entered by the system, based on automated evaluation process.

7. The system of claim 3, wherein at least some of the virtual exposure modes are pre-set by the system and at least some data in at least some of the sets of social media data is automatically selected by the system prior to the implementation.

8. The system of claim 1, wherein at least one of the virtual exposure modes of the plurality of virtual exposure modes is linked with a set of graphic enhancements of a social media space.

9. The system of claim 21 wherein the linking data, comprising the information for proper association of each virtual exposure mode of the plurality of virtual exposure modes with corresponding social media data, comprises associations for deletion of at least some of the data of social media data in a social media environment.

10. The system of claim 1, wherein the plurality of virtual exposure modes comprises more than two virtual exposure modes.

11. The system of claim 1, wherein at least one of the plurality of virtual exposure modes is user-created.

12. A computer-implemented method of virtual exposure management for alteration of user's exposure characteristics in a social media environment, the computer-implemented method comprising the steps of:
a. establishing a plurality of virtual exposure modes,
c. correlating at least one virtual exposure mode of the plurality of virtual exposure modes to a set of social media data;
d. providing a communication device, said communication device comprising an input device and a display device;
e. providing a GUI interface, said GUI interface configured to allow for user's selection of a set of options on the display device, said set of options comprising the selection of a virtual exposure mode out of the plurality of virtual exposure modes;
f. providing a database, comprising a set of linking data,
g. said linking data comprising information for proper association of each virtual exposure mode of the plurality of virtual exposure modes with corresponding social media data
h. providing a processing device, said processing device configured for processing and implementation of the user's selection from the set of options;
i. receiving the user's selection of options on the GUI interface
j. transforming the user's selection of options on the GUI interface into an action command sequence,
k. accessing social media environment
l. carrying out said command sequence to alter the social media data effecting the user's exposure characteristics in the social media environment, and
m. providing the user with the confirmation of action.

13. The method of claim 12, further comprising the step of correlating at least one virtual exposure mode of the plurality of virtual exposure modes to a set of virtual persona characteristics;

14. The method of claim 12, wherein information for proper association of each virtual exposure mode of the plurality of virtual exposure modes with corresponding social media data is obtained from user-selection;
and wherein the confirmation of action comprises the publication of such confirmation on the display device.

15. The method of claim 12, wherein the linking data comprises information for both positive and negative actions.
